(19) United States
(12) Patent Application Publication
(10) Pub. No.: US 2025/0272917 A1
(43) Pub. Date: Aug. 28, 2025

(54) SPACE VISUALIZATION SYSTEM AND SPACE VISUALIZATION METHOD

(71) Applicant: Hitachi, Ltd., Chiyoda-ku, Tokyo (JP)

(72) Inventors: Yuki WATANABE, Tokyo (JP); Soichiro OKAZAKI, Tokyo (JP); Ryosuke MIKI, Tokyo (JP); Tomoaki YOSHINAGA, Tokyo (JP); Atsushi HIROIKE, Tokyo (JP)

(21) Appl. No.: 18/858,256

(22) PCT Filed: Feb. 14, 2023
(86) PCT No.: PCT/JP2023/005004

§ 371 Date: Oct. 18, 2024

(30) Foreign Application Priority Data
Apr. 21, 2022 (JP) 2022-070193

(51) Int. Cl. G06T 17/05; G06T 7/62; G06T 7/70; G06V 10/44; G06V 10/74; G06V 10/762

(52) U.S. Cl. CPC G06T 17/05; G06T 7/62; G06T 7/70; G06V 10/44; G06V 10/761; G06V 10/762; G06V 2201/07

(57) ABSTRACT

A space visualization system includes: a calculation device configured to execute predetermined calculation processing; and a storage device accessible by the calculation device. The calculation device includes a spatial structure recognition unit configured to construct a spatial structure based on a plurality of images. The calculation device includes an image semantic recognition unit configured to detect an object included in each of the plurality of images. The calculation device includes an image semantic and spatial structure fusion unit configured to estimate a spatial position of the detected object on the spatial structure. The storage device stores information on the image as a source of constructing the spatial structure, the constructed spatial structure, and information on the detected object.

### CROSS-REFERENCE TO RELATED APPLICATION

The present application claims the priority of Japanese Patent Application No. 2022-70193, filed on Apr. 21, 2022, the entire contents of which are incorporated herein by reference.

### TECHNICAL FIELD

The present invention relates to a space visualization system.

### BACKGROUND ART

Disasters due to global warming frequently occur, and a delay in response due to shortage of on-site personnel and a threat to life and property due to expansion of damage increase. At the time of occurrence of a disaster, it is necessary to quickly grasp a wide-area damage situation and take measures to minimize the damage as quickly as possible, such as guiding people to an evacuation route. In addition, it is necessary to perform an inspection operation in a wide area in order to detect an abnormal change in an infrastructure even during peacetime. In order to quickly grasp a situation over a wide area and detect an abnormal change, automatic video analysis using artificial intelligence (AI) technology is attracting attention, which targets not only a video captured by a fixed surveillance camera, but also by a mobile type wearable camera and an unmanned aerial vehicle (UAV). In addition, a method for reconstructing a three-dimensional spatial structure from a plurality of images by a photogrammetry technique or the like is proposed, and an overhead situation can be grasped from an image captured by a mobile type camera.

The following PTL is included as background art in the present technical field. PTL 1 (JP2019-211257A) discloses an inspection system for inspecting an inspection object, the inspection system including: a three-dimensional model generation unit that generates a three-dimensional model of the inspection object based on a plurality of images obtained by imaging the inspection object by a flight device including a camera; an imaging information acquisition unit that acquires, for each of the plurality of images, an imaging position at which the image in a three-dimensional coordinate system is imaged and a viewpoint axis direction of the camera; an abnormality detection unit that detects an abnormality of the inspection object based on the image for each of the plurality of images; an abnormal position identification unit that identifies, for the detected abnormality, an abnormal position which is a position in the three-dimensional coordinate system according to the imaging position and the viewpoint axis direction; and a three-dimensional model display unit that displays the three-dimensional model in which the abnormal position is mapped. Accordingly, an abnormal portion detected on the image can be easily identified on the three-dimensional model, and can be quickly and accurately provided to a user.

### SUMMARY OF INVENTION

### Technical Problem

PTL 1 assumes an application to the inspection system, and a distance between the imaging device and the inspection object is relatively short and does not change greatly. All that is required is for a user to be able to pinpoint the image of the abnormal portion identified on the three-dimensional model. Meanwhile, when a wide variety of objects and events, large and small, scattered over a wide range, such as in a disaster situation, are imaged from various distances and angles, it is difficult to grasp the entire situation based on the coordinates of the object indicated by the pinpoint as in PTL 1. When there are a large number of detection points, acquiring an image based only on a coordinate designation by the user on the three-dimensional model requires the user to carry out cumbersome operations, making it difficult to obtain a desired image.

### Solution to Problem

A representative example of the invention disclosed in the present application is as follows. That is, a space visualization system includes: a calculation device configured to execute predetermined calculation processing; and a storage device accessible by the calculation device. The calculation device includes a spatial structure recognition unit configured to construct a spatial structure based on a plurality of images. The calculation device includes an image semantic recognition unit configured to detect an object included in each of the plurality of images. The calculation device includes an image semantic and spatial structure fusion unit configured to estimate a spatial position of the detected object on the spatial structure. The storage device stores information on the image as a source of constructing the spatial structure, the constructed spatial structure, and information on the detected object.

### Advantageous Effects of Invention

According to an aspect of the present invention, a wide variety of objects and events, large and small, scattered over a wide range, such as in a disaster situation, can be appropriately visualized in a spatial structure, allowing the situation to be quickly grasped. Problems, configurations, and effects other than those described above will be clarified by the description of the following embodiments.

### BRIEF DESCRIPTION OF DRAWINGS

FIG. 1 is a block diagram showing a configuration example of a space visualization system according to Embodiment 1.

FIG. 2 is a block diagram showing a hardware configuration example of the space visualization system according to Embodiment 1.

FIG. 3A is a diagram showing a configuration example of an image database according to Embodiment 1.

FIG. 3B is a diagram showing the configuration example of the image database according to Embodiment 1.

FIG. 3C is a diagram showing the configuration example of the image database according to Embodiment 1.

FIG. 4 is a diagram showing an outline of spatial structure construction processing performed by a spatial structure recognition unit according to Embodiment 1.

FIG. 5 is a diagram showing an outline of image recognition processing performed by an image semantic recognition unit according to Embodiment 1.

FIG. 6 is a diagram showing an outline of processing performed by an image semantic and spatial structure fusion unit according to Embodiment 1.

FIG. 7 is a flowchart of database registration processing according to Embodiment 1.

FIG. 8 is a schematic diagram showing space visualization and image search processing performed by an image search device according to Embodiment 1.

FIG. 9 is a flowchart of the space visualization and image search processing performed by the image search device according to Embodiment 1.

FIG. 10 is a diagram showing an outline of object information summary processing according to Embodiment 1.

FIG. 11 is a flowchart of summary processing performed by an image search device according to Embodiment 2.

FIG. 12 is a diagram showing an image search utilizing a context of a three-dimensional viewer according to Embodiment 3.

FIG. 13 is a flowchart of context-utilizing image search processing of an image search device according to Embodiment 3.

FIG. 14 is a diagram showing a configuration example of an operation screen for performing visualization of space information and the image search using the image search device according to Embodiments 1 to 3.

FIG. 15 is a sequence diagram showing an example of processing of the space visualization system according to Embodiment 1.

### DESCRIPTION OF EMBODIMENTS

Hereinafter, embodiments of the invention will be described with reference to the accompanying drawings. The present embodiments are merely examples for implementing the invention, and do not limit the technical scope of the invention. In the drawings, the same reference numerals are given to the same configurations.

### Embodiment 1

An image search device 104 according to the present embodiment analyzes an image acquired by a mobile type imaging device to form a spatial structure. In addition, semantic information of an object (an object or an event) included in the image is detected, a position and a size of the detected object in a spatial structure are estimated, and an image database 110 that holds both space information and semantic information is constructed. Since a user can check the detected object in an overhead view on the spatial structure, the user can quickly grasp an event that occurs over a wide area without checking each and every image captured. In the present embodiment, “space” is used in the meaning of a three-dimensional space unless otherwise specified.

An object to be detected in image semantic recognition processing may be an object with a clearly recognizable boundary with a background, such as a person and a car, or an irregular event, such as a landslide, fire, and smoke. However, since it is necessary to obtain a position on the spatial structure, an event occurring in a region where no structure information exists (for example, the air) cannot be accurately handled. In this case, it can be used for a use case for visualizing an approximate position.

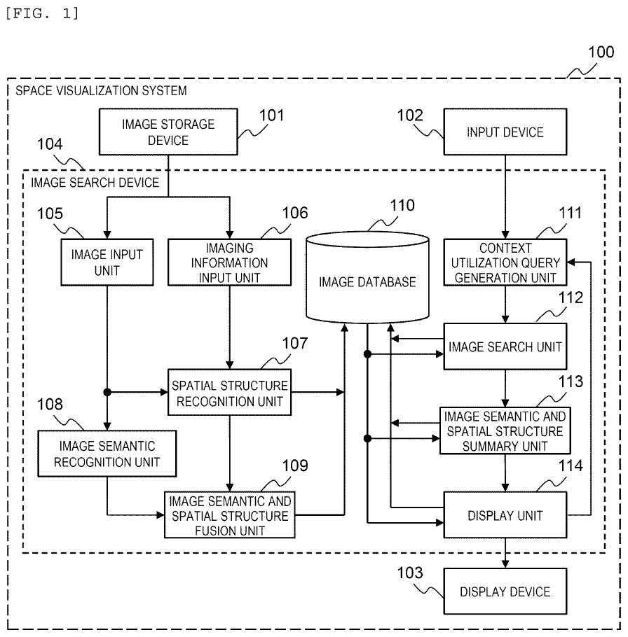

FIG. 1 is a block diagram showing a configuration example of a space visualization system 100 according to Embodiment 1.

The space visualization system 100 may include the following use cases, and is not limited thereto.
(1) Grasping of disaster situation: By grasping a landslide, flood, fire, which occur over a wide range, as well as positions of people, vehicles, buildings, and the like, the disaster situation is utilized for a rescue operation and restoration planning.
(2) Infrastructure maintenance: By periodically inspecting deterioration or breakage of buildings, bridges, and the like, collapse is prevented in advance.
(3) Inventory management: By digitizing an amount of materials and assets stored outdoors or in a large-scale warehouse, a supply chain is optimized. In addition, inventory loss is prevented by detecting an abnormality at an early stage.
(4) Wide-area security: A flow of people or vehicles over a wide range that cannot be covered by a fixed monitoring camera, an accident, or an event is detected, and a warning is given in an overhead view.

In the present embodiment, an unmanned aerial vehicle (UAV) is assumed as an imaging device, and the space visualization system 100 can be applied to data acquired by any imaging device such as a wearable camera as long as a self-position and a posture of the imaging device can be acquired or estimated. The “self-position” refers to three-dimensional coordinates of an imaging device in real space, and in the case of the UAV, the self-position can be acquired using a global navigation satellite system (GNSS) or an altitude sensor. The “posture” is rotation information of the imaging device, and can be acquired by a gyro sensor in the UAV.

Hereinafter, each configuration will be described by taking a disaster situation grasping application as an example.

The space visualization system 100 constructs the image database 110 by analyzing a video acquired by a mobile type imaging device, and presents to the user an object detection result arranged on the spatial structure. The space visualization system 100 includes an image storage device 101, an input device 102, a display device 103, and the image search device 104.

The image storage device 101 is a storage medium that stores image data of a still image or a video and attribute information accompanying the image data, and can be implemented by a hard disk drive built in a computer, a storage device (for example, a network attached storage (NAS) or a storage area network (SAN)) connected via a network, or the like. The image storage device 101 may be a cache memory that temporarily holds data continuously input from the imaging device. The image storage device 101 may be included in a storage device 202.

The input device 102 is an input interface such as a mouse, a keyboard, or a touch device for transmitting a user operation to the image search device 104. When the input device 102 is a device equipped with an acceleration sensor such as a smartphone, a tablet, or a head-mounted display, posture information of the input device 102 can be input to the image search device 104. The display device 103 is an output interface such as a liquid crystal display, and is used for displaying a search result by the image search device 104, an interactive operation with a user, and the like.

The image search device 104 is a device that extracts space information and image semantic information necessary for search, executes registration processing for making a database, and executes visualization and image search processing of a spatial structure using registered data. Hereinafter, the registration processing will be described.

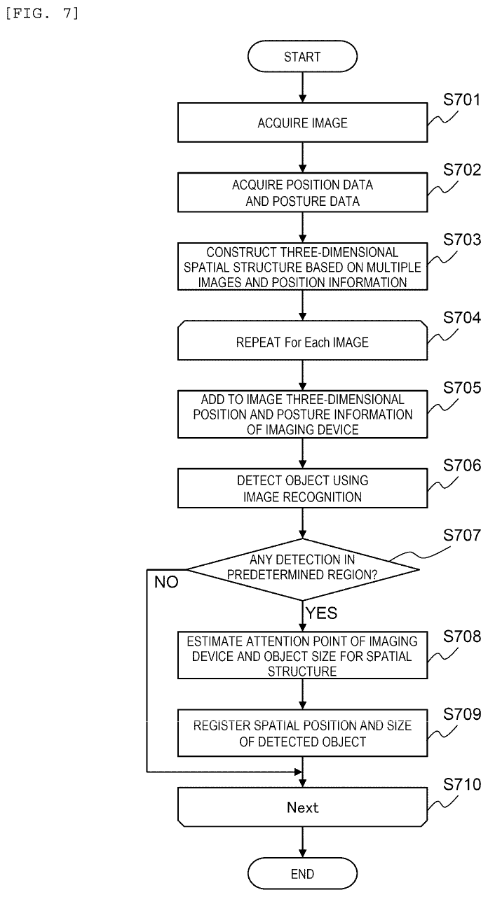

In the registration processing, the image search device 104 constitutes a spatial structure based on an image and attribute information accumulated in the image storage device 101, extracts the image semantic information, combines the image semantic information and the spatial structure, and registers the combined information in the image database 110. A spatial structure is expressed as a set of points in a three-dimensional space, and a mesh can be expressed by describing connection of points. Further, by adding image data corresponding to a mesh, the spatial structure with texture can be expressed. The image semantic information includes information on a type of an object contained in the image and its position on a two-dimensional image. The image semantic information with space information includes information on a three-dimensional position and a size of the object on the spatial structure in addition to the image semantic information. Details of the registration processing will be described with reference to FIG. 7.

In the spatial structure visualization and image search processing, search processing is executed to search the image database 110 for an image matching a search condition using the search condition designated by the user from the input device 102, and to present information on the display device 103. The image search device 104 can provide the user with a three-dimensional viewer using the spatial structure read from the image database 110. By using the image semantic information with space information, information on an object obtained by image recognition can be displayed on a spatial structure displayed three-dimensionally. Accordingly, the user can intuitively grasp an outline of a spatial distribution of an image recognition result. The image information corresponding to the region designated by the three-dimensional viewer can be easily acquired.

The image search device 104 includes an image input unit 105, an imaging information input unit 106, a spatial structure recognition unit 107, an image semantic recognition unit 108, an image semantic and spatial structure fusion unit 109, the image database 110, a context utilization query generation unit 111, an image search unit 112, an image semantic and spatial structure summary unit 113, and a display unit 114.

The image input unit 105 receives an input of still image data or video data from the image storage device 101, and converts the input data into a data format to be used in the image search device 104. For example, when the data received by the image input unit 105 is the video data, the image input unit 105 executes video decoding processing of decomposing the data into frames (still image data format).

The imaging information input unit 106 receives, from the image storage device 101, data in which the position information and the posture information of the imaging device are recorded. The position information refers to three-dimensional coordinates of the imaging device in the real space, and the posture information represents a rotation angle of the imaging device. The position information and the posture information are acquired for each image acquired by the image input unit 105. In addition, camera parameters such as an imaging time, a moving speed, an acceleration, a viewing angle, a focal length, and a lens distortion may be received.

The spatial structure recognition unit 107 constructs a spatial structure based on a plurality of images acquired by the image input unit 105. For the construction of the spatial structure based on the plurality of images captured from different viewpoints, structure from motion (SfM), visual simultaneous localization and mapping (vSLAM), and other known photogrammetry techniques can be used. At this time, by providing the position and the posture in the real space acquired by the imaging information input unit 106, the camera parameters, and the like as auxiliary information, a more accurate configuration is possible. When there is no position and posture information for the image, an estimated value is obtained in the process of spatial structure construction processing, and thus estimated position and posture information are used in the subsequent processing.

The image semantic recognition unit 108 executes image recognition processing on each image acquired by the image input unit 105 to detect an object or an event in the image. For the image recognition processing, a known image classification method, object detection method, region estimation method, or the like can be used. In many methods in recent years, a recognition model can be formed by machine learning, and any target can be detected by changing a model to be used. One model capable of detecting a plurality of types of targets may be used, or a plurality of models may be used according to the types. As a result of the image recognition processing, two-dimensional coordinates of an object in an image, the type of the object, and reliability of a recognition result are obtained.

The image semantic and spatial structure fusion unit 109 obtains the three-dimensional position and size of the object in the spatial structure formed by the spatial structure recognition unit 107 based on the position and posture information of the image acquired by the imaging information input unit 106 and the two-dimensional coordinates of the object obtained by the image semantic recognition unit 108, and stores the information obtained by the series of processing described above in the image database 110. The three-dimensional position of the object can be estimated by obtaining three-dimensional coordinates that collide with the spatial structure when a straight line is extended on an optical axis from center coordinates of the object in the image using the position and posture information of the image. The size of the object may be a value set in advance according to the type of the object, or may be calculated using the size of the object on the image and a distance to a collision point between the image and the spatial structure. The image semantic and spatial structure fusion unit 109 may extract an image feature obtained by digitizing a visual feature in the image and store the image feature in the image database 110. The image feature is usually given by fixed-length vector data, and images with a short vector distance have high visual similarity, and therefore can be used for similar image search as necessary in space visualization and image search processing described below.

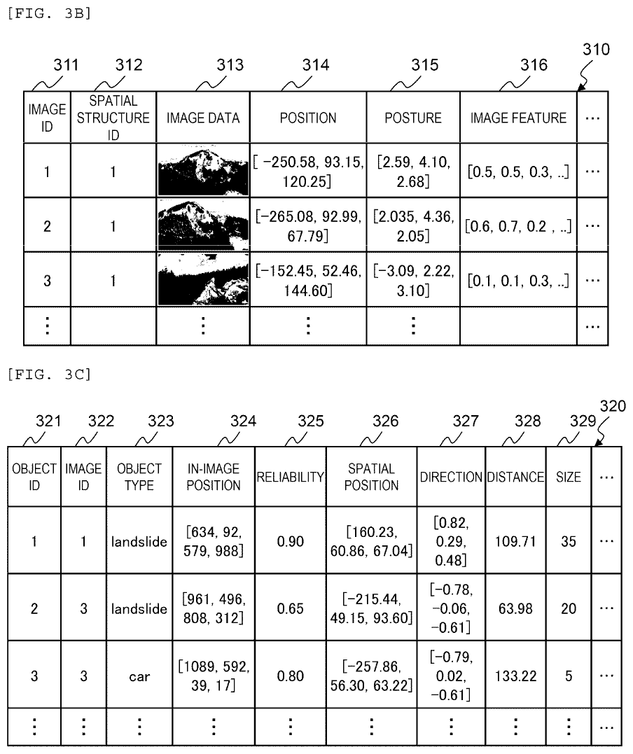

The image database 110 holds spatial structure information, image information, and object information obtained by the registration processing. In response to an inquiry from each unit of the image search device 104, the image database 110 can search for registration data satisfying a query condition and output data of a designated ID. By using the image feature, a registered image similar to a query image can be output. Details of the structure of the image database 110 will be described later with reference to FIGS. 3A to 3C.

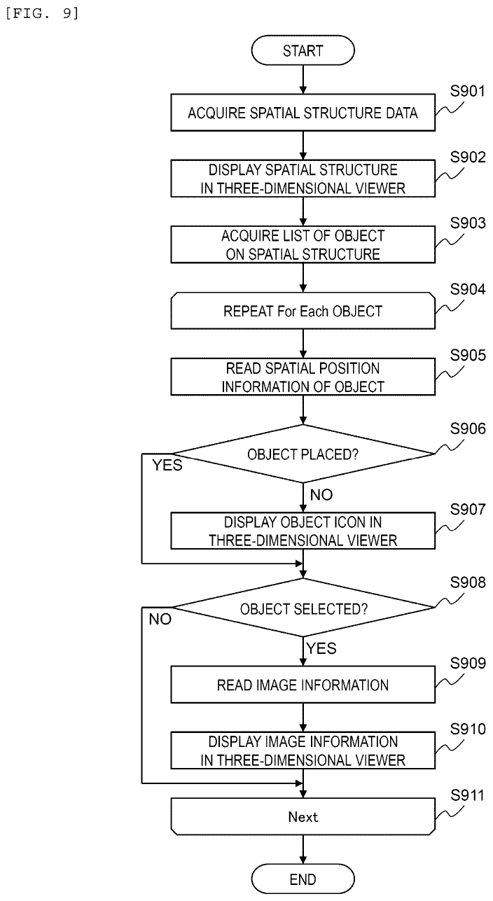

The above is the operation of each unit in the registration processing of the image search device 104. Next, the operation of each unit in the space visualization and image search processing of the image search device 104 will be described. Details of the space visualization and image search processing will be described with reference to the flowchart of FIG. 9.

The context utilization query generation unit 111 receives operation information of the user from the input device 102, receives a state of the spatial structure presented to the user from the display unit 114, and generates an image search query based on the information. The query may be a condition such as a spatial structure identifier, a type of an object, or a position of the object, or may be an image feature for similarity search. In addition, a combination of one or more conditions and the image feature may be used, and a priority or a weight may be added to the image feature or the condition.

The image search unit 112 searches the image database 110 for the object information using the query generated by the context utilization query generation unit 111. For example, when the query is given under a condition, registration data matching the condition is output, and when the query is given by an image feature represented by the vector data, a distance between vectors is calculated, and the registration data is output in descending order of similarity (distance between vectors is small).

The image semantic and spatial structure summary unit 113 summarizes data to be presented to the user in response to the search result obtained by the image search unit 112. Summary processing may be skipped according to an instruction of the user and all the search results may be displayed. In the summary processing, for example, objects of the same type whose spatial positions are close to each other are determined to be duplicate data and excluded, or objects are determined to be one three-dimensional object and combined.

The display unit 114 displays the spatial structure read from the image database 110 on the three-dimensional viewer, and visualizes the spatial structure at a viewpoint designated by the user from the input device 102. An image search result obtained from the image semantic and spatial structure summary unit 113 is superimposed and displayed on the three-dimensional viewer. The object obtained by the image recognition of the registration processing has the information of the spatial position, and therefore may be arranged as an icon on the spatial structure, for example. If necessary, the image data and the attribute information may be read from the image database 110, and the image is processed and displayed on a screen.

The operation of each unit in the space visualization and image search processing of the image search device 104 is described above. The registration processing and the space visualization and image search processing of the image search device 104 may be executed simultaneously. For example, the invention can be applied to a real-time system in which, when enough images are input to construct a spatial structure, the constructed spatial structure can be displayed on the display device 103 while an object is detected based on a newly input image, and the detected object is sequentially added and displayed on the viewer. Although the method is limited to the vSLAM or the like, the latest spatial structure can be displayed on the viewer by using a method for updating the spatial structure for images that are input sequentially.

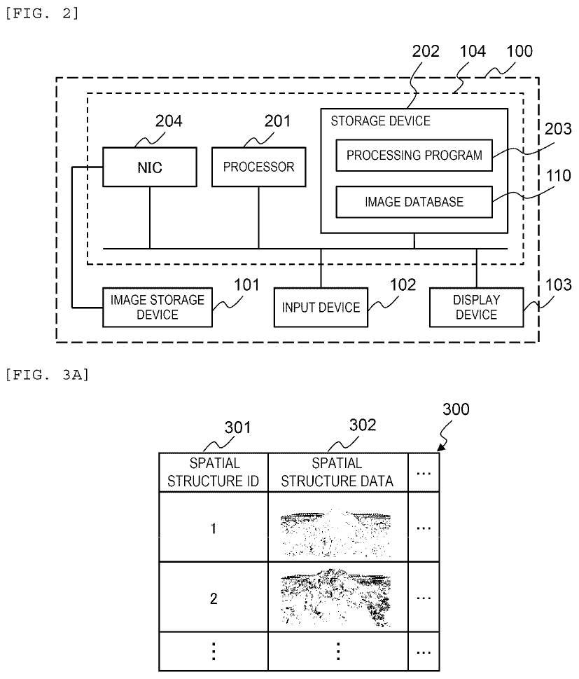

FIG. 2 is a block diagram showing a hardware structure example of the space visualization system 100 according to the present embodiment.

The image search device 104 includes a processor 201, the storage device 202, and a network interface device (NIC) 204. The processor 201, the storage device 202, and the network interface device 204 are connected by, for example, a bus.

The storage device 202 is implemented by any type of storage medium, for example, a combination of a semiconductor memory and a hard disk drive. Functional units such as the image input unit 105, the imaging information input unit 106, the spatial structure recognition unit 107, the image semantic recognition unit 108, the image semantic and spatial structure fusion unit 109, the context utilization query generation unit 111, the image search unit 112, the image semantic and spatial structure summary unit 113, and the display unit 114 shown in FIG. 1 are implemented by the processor 201 executing a processing program 203 stored in the storage device 202. In other words, the processing executed by each functional unit is executed by the processor 201 based on a procedure defined in the processing program 203. The data of the image database 110 is stored in the storage device 202. When the space visualization system 100 includes a plurality of devices for the purpose of a processing load distribution or the like, the device including the image database 110 and the device executing the processing program 203 may be physically different devices connected via a network.

The program executed by the processor 201 is provided to the image search device 104 via a removable medium (CD-ROM, flash memory, or the like) or a network, and is stored in a nonvolatile non-transitory storage medium (for example, a hard disk drive) of the storage device 202. Therefore, the space visualization system 100 may include an interface for reading data from the removable medium.

The image search device 104 is a computer system implemented on one physical computer or a plurality of computers implemented logically or physically, and may operate on a virtual computer constructed on a plurality of physical computer resources. For example, the registration processing and the space visualization and image search processing may operate on different physical or logical computers, or may operate on one physical or logical computer.

FIGS. 3A, 3B, and 3C are diagrams showing configuration examples of the image database 110 according to the present embodiment.

In the present embodiment, the information used by the image search device 104 may be expressed by any data structure without depending on the data structure. FIGS. 3A, 3B, and 3C show examples in a table format, and information can be stored in a data structure appropriately selected from, for example, a table, a list, a database or a queue.

The image database 110 includes, for example, a spatial structure table 300 (FIG. 3A) that holds a spatial structure, an image table 310 (FIG. 3B) that holds image information, and an object table 320 (FIG. 3C) that holds object information. Table configurations and field configurations of the tables are examples, and the tables and the fields may be added or deleted according to an application, for example. The table configuration may be changed as long as the same information is held. For example, the image table 310 and the object table 320 may be combined into one table.

The spatial structure table 300 shown in FIG. 3A includes a spatial structure ID field 301 and a spatial structure data field 302.

The spatial structure ID field 301 holds unique identification information of each piece of spatial structure information. The spatial structure data field 302 holds the constructed spatial structure data. The spatial structure data includes three-dimensional vertex coordinate points, mesh structure information connecting the vertex coordinate points, texture image data, and the like. When displaying in a three-dimensional viewer, these are required for point cloud display, mesh display, and textured mesh display, but may be stored in any format as long as it is compatible. If the type of display can be limited, such as to only the point cloud or only the mesh, then only a part of data may be held.

The image table 310 shown in FIG. 3B includes an image ID field 311, a spatial structure ID field 312, an image data field 313, a position field 314, a posture field 315, and an image feature field 316. If necessary, a field such as an imaging timing of an image may be included.

The image ID field 311 holds unique identification information of each piece of image information. The spatial structure ID field 312 refers to a space in which the image is captured, and holds the spatial structure ID managed by the spatial structure table 300. The image data field 313 holds image data used for screen display in binary. The position field 314 holds a three-dimensional position in a space in which an image is captured. The three-dimensional position may be, for example, an absolute position represented by a coordinate system in a real space such as [latitude, longitude, altitude] or a relative position such as <x, y, z> in a coordinate system of a spatial structure. The posture field 315 holds data representing a rotation angle of the imaging device. The rotation angle can be expressed by various methods as long as the posture of the imaging device in the spatial structure can be appropriately reproduced when the posture information is used in the image semantic and spatial structure fusion unit 109 or the display unit 114. For example, the rotation angle may be expressed by a three-dimensional vector of [roll, pitch, yaw], or may be expressed by a four-dimensional vector such as a quaternion. The image feature field 316 holds a numerical vector representing a feature of the entire image.

The object table 320 shown in FIG. 3C includes an object ID field 321, an image ID field 322, an object type field 323, an in-image position field 324, a reliability field 325, a spatial position field 326, a direction field 327, a distance field 328, and a size field 329.

The object ID field 321 holds unique identification information of each piece of object information. The image ID field 322 refers to an original image from which an object is detected, and holds the image ID managed by the image table 310. The object type field 323 holds a type of an object. The type of the object may be directly held as a character string as illustrated, or may be held as a numerical value corresponding to the type. The in-image position field 324 holds position information of the object in the image. For example, when a region of the object is represented by a rectangle, it can be represented by a four-dimensional vector of [upper left x coordinate, upper left y coordinate, width w, height h]. The reliability field 325 holds a numerical value representing reliability of an image recognition result. For example, the value is in the range from 0.0 to 1.0, and 1.0 is the highest reliability. The spatial position field 326 holds the coordinates of the object in the three-dimensional space calculated by the image semantic and spatial structure fusion unit 109. The direction field 327 holds a direction of a straight line connecting the imaging device and the object in the three-dimensional space. Based on the value of the direction, it is possible to know from which angle the object is imaged. The distance field 328 holds a length of the straight line connecting the imaging device and the object in the three-dimensional space. Based on the distance value, it is possible to know how far the object is imaged. The size field 329 holds the size information of the object in the three-dimensional space calculated by the image semantic and spatial structure fusion unit 109. The size information may be, for example, a radius, a range on each axis of x, y, and z, or mesh data surrounding an object. In the following example, for simplicity, the radius is used as the size information.

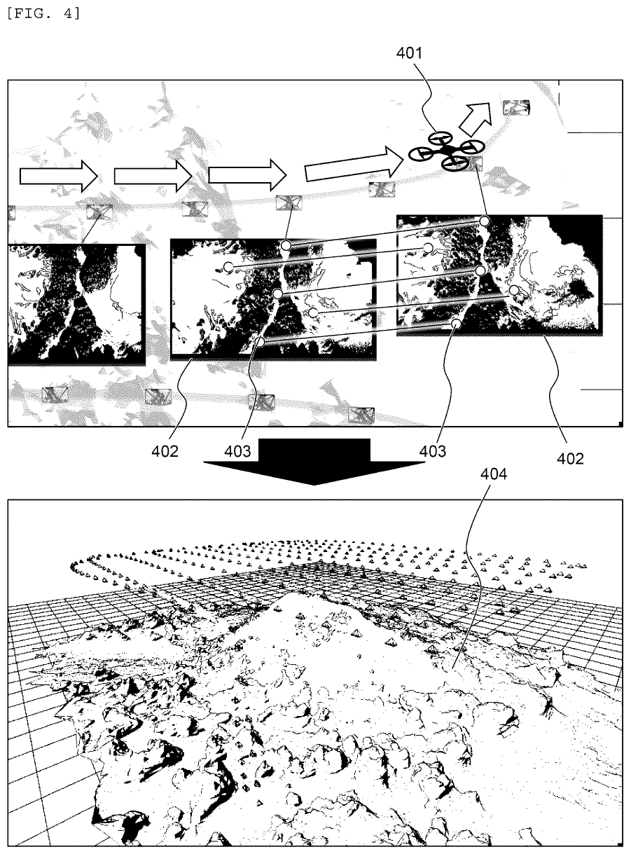

FIG. 4 is a diagram showing an outline of the spatial structure construction processing by the spatial structure recognition unit 107 according to the present embodiment.

A known method such as SfM or vSLAM can be used for the spatial structure construction. For the spatial structure construction, a plurality of images 402 of different viewpoints acquired by the imaging device 401 are necessary. A large number of feature points 403 are extracted from each image, and matching processing of the feature points is performed between the images to find same points appearing in the plurality of images. A position and a posture of an imaging device are estimated, and a three-dimensional position of a point obtained based on the principle of triangulation is estimated. At this time, accuracy of the position may be improved with reference to real-world position information or the posture information corresponding to the image. By repeating the processing, a set of a large number of three-dimensional points (point cloud) can be acquired. Then, adjacent points are connected to generate a mesh, and a texture is projected onto the mesh. A constructed spatial structure 404 can be displayed from various viewpoints by a three-dimensional viewer.

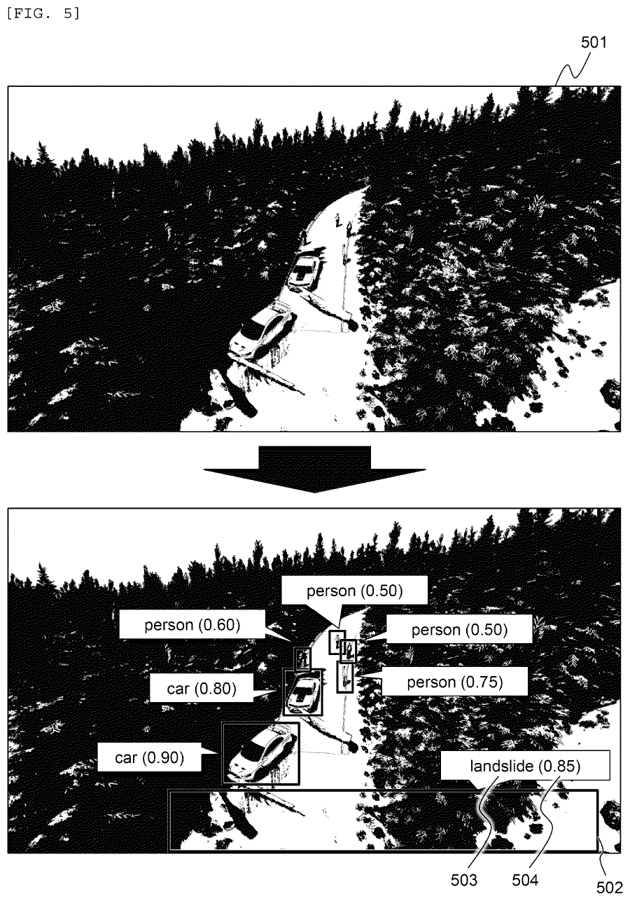

FIG. 5 is a diagram showing an outline of the image recognition processing performed by the image semantic recognition unit 108 according to the present embodiment.

In the image recognition processing, objects such as a person, a car, and a building included in an input image 501 and events such as landslide, fire, and smoke are detected. A known method such as an object detection method or a region detection method using a model that reacts to an object region trained by deep learning can be used for image recognition. As a result of the processing, for example, image semantic information including a rectangle 502 surrounding the object region, an object type 503, and recognition reliability 504 is obtained.

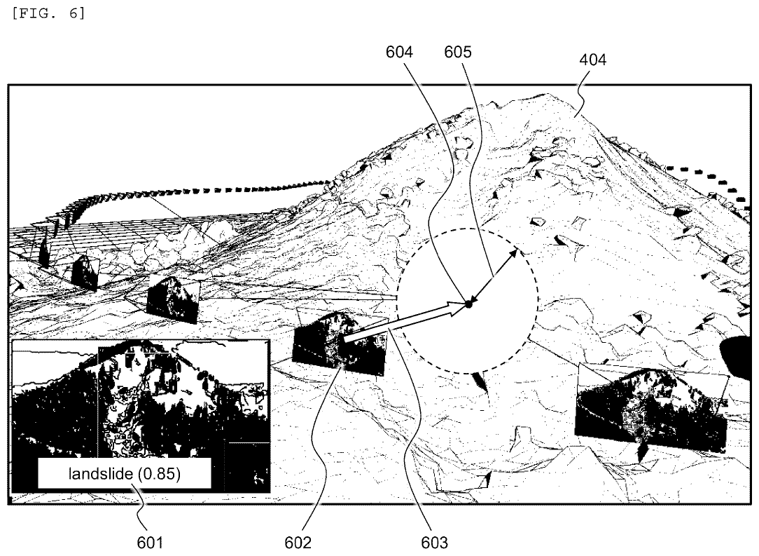

FIG. 6 is a diagram showing an outline of processing performed by the image semantic and spatial structure fusion unit 109 according to the present embodiment.

The image semantic and spatial structure fusion unit 109 obtains a three-dimensional position and a size in the spatial structure 404 of an object 601 detected by the image semantic recognition unit 108. First, the three-dimensional position and the posture of an image 602 including the object are obtained based on data recorded at the time of imaging or a value estimated by the spatial structure recognition unit 107. Next, a straight line 603 is extended on the optical axis from the position and the posture of the image, and a point 604 that collides with the spatial structure 404 is obtained and set as the three-dimensional position of the object. A size 605 of the object may be obtained using a predetermined value based on the type of the object, or a value obtained by enlarging a rectangular size of the object in the image in proportion to a distance between the image in the three-dimensional space and the object.

In recognition processing and database registration processing of the input image, any procedure may be used for the registration as long as the information on the database in the configuration examples shown in FIGS. 3A to 3C is accumulated, and for example, the procedure shown in the flowchart of FIG. 7 may be used.

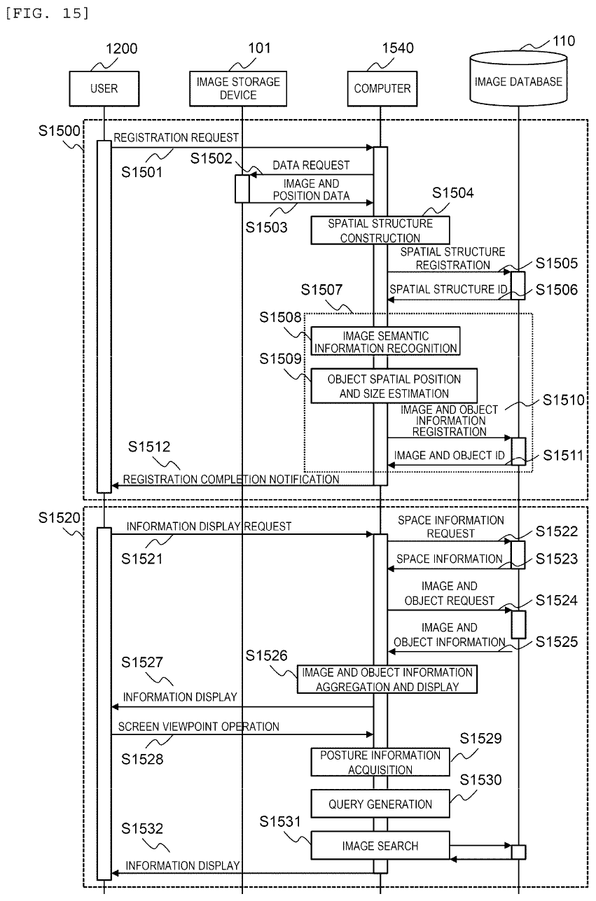

FIG. 7 is a flowchart of the database registration processing. Hereinafter, each step in FIG. 7 will be described. An execution trigger of the data registration processing is to input an image data group imaged by the user to the system. Details of the trigger will be described later with reference to FIG. 15 which is an overall sequence diagram of the registration processing and the search processing.

The image input unit 105 acquires the image data from the image storage device 101, and converts the acquired image data into a format usable in the system as necessary (S701). For example, when an input of video data is received, video decoding processing of decomposing the video data into frames (still image data format) is conversion processing.

The imaging information input unit 106 acquires data on a position and a posture of the imaging device at the time of imaging, which is recorded in the image storage device 101, and converts the coordinate system as necessary (S702).

The spatial structure recognition unit 107 constructs a spatial structure using an image set acquired in step S701 and the data of the positions and postures of the images acquired in step S702, and registers the spatial structure data in the image database 110 (S703). As a result, the spatial structure data such as a point cloud, a mesh, or a mesh with texture can be acquired.

The image search device 104 executes the procedure from step S705 to step S709 on each of the images acquired in step S701 (S704).

The spatial structure recognition unit 107 adds information on the three-dimensional position and the posture to the image acquired in step S701 based on at least one of the information of the imaging device acquired in step S702 and a value estimated in the processing process of the spatial structure construction in step S703, and registers the image information in the image database 110 (S705).

The image semantic recognition unit 108 detects an object from the image acquired in step S701 by the image recognition processing (S706). As a result, the position and size of the object on the two-dimensional coordinates in the image are obtained.

The image semantic and spatial structure fusion unit 109 executes the procedure of step S708 when an object is detected in a predetermined region in step S706, and proceeds to step S710 when an object is not detected in the predetermined region (step S707). Here, the predetermined region is a region that is not greatly away from the optical axis of the imaging device (a perpendicular line to the center position of the image). The object at a position away from the optical axis may be excluded as necessary, since an error may be large when obtaining the position in the spatial structure if the camera parameters are not accurately reflected. When it is desired to keep a large number of object detection results, it is preferable to record position estimation reliability which is inversely proportional to the distance from the center coordinates in the image database 110 and narrow down the object to be displayed according to the position estimation reliability.

The image semantic and spatial structure fusion unit 109 estimates the three-dimensional position and size of the object in the spatial structure based on the two-dimensional position of the object in the image obtained in step S706, the three-dimensional position and the posture of the image obtained in step S705, and the spatial structure constructed in step S703 (S708). In the processing, as described in the description of FIG. 6, the position and size of the object are obtained by obtaining the distance between the straight line extending on the optical axis from the image and the point where the spatial structure collides with the straight line.

The image semantic and spatial structure fusion unit 109 registers the object information obtained in steps S706 to S708 in the image database 110 (S709). The image semantic and spatial structure fusion unit 109 may calculate an image feature as necessary and store the image feature in the image feature field 316 of the image table 310 of the image database 110.

After completing the processing for all the images, the image semantic recognition unit 108 ends the registration processing (S710). When new data is continuously recorded in the image storage device 101, the processing waits until the new data is stored, and then returns to step S701 to repeat the registration processing.

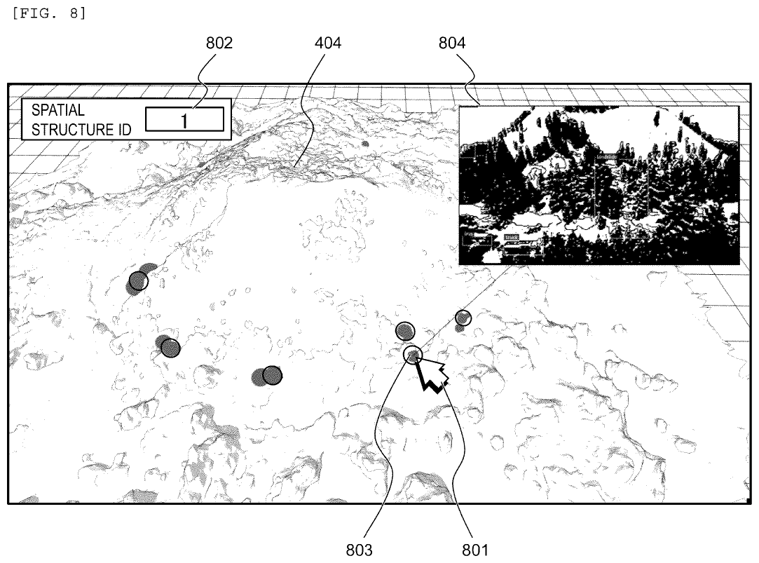

FIG. 8 is a diagram showing the space visualization and image search processing performed by the image search device 104 according to the present embodiment.

The spatial structure, the image information, and the object information stored in the image database 110 are displayed on the display device 103 according to a user operation from the input device 102. The user operates a user interface displayed on a screen with a mouse cursor 801 or the like. For example, when a spatial structure ID is input to a spatial structure ID input form 802, the context utilization query generation unit 111 generates a query for acquiring the spatial structure of the input ID, and the image search unit 112 acquires information of the spatial structure and an object included in the space from the image database 110. The image semantic and spatial structure summary unit 113 aggregates the object information acquired from the image database 110 as necessary. For example, objects whose spatial positions are close are grouped. The display unit 114 displays the spatial structure 404 and an icon 803 of the object on the display device 103. When the user selects the icon of the object, detailed information of an original image from which the object is detected is acquired from the image database 110, and the image is displayed in a pop-up window 804.

FIG. 9 is a flowchart of the space visualization and image search processing performed by the image search device 104 according to the present embodiment. Hereinafter, each step in FIG. 9 will be described.

The context utilization query generation unit 111 acquires a user screen operation from the input device 102 and receives the ID of the spatial structure. The image search unit 112 acquires the spatial structure data of the designated ID from the image database 110 (S901).

The display unit 114 displays the spatial structure represented by the spatial structure data acquired in step S901 on the display device 103 using the three-dimensional viewer (S902).

The image search unit 112 acquires an object ID list on the spatial structure of the designated ID from the image database 110 (S903).

The image search device 104 executes the procedure from step S905 to step S910 for each of the object ID acquired in step S903 (S904).

The image semantic and spatial structure summary unit 113 acquires the object information from the image database 110 (S905).

The image search device 104 executes step S908 if another object is already placed near the spatial position of the object, and executes step S907 if another object is not placed (S906).

The display unit 114 arranges an icon of the object so as to be superimposed on the spatial structure displayed in step S902 (S907). A style such as a size or color of the icon may be changed according to an estimated size of the object.

The image search device 104 executes step S909 when the user selects an object icon, and executes step S911 when the user does not select the object icon (S908).

The image search unit 112 acquires the image information in which the selected object is detected from the image database 110 (S909).

The display unit 114 uses the three-dimensional viewer to display details of the image information acquired in step S909 in the pop-up window by superimposing the details on the spatial structure displayed in step S902 (S910).

When the processing for all the object IDs is completed, the image search device 104 ends the visualization and image search processing (S911). Steps S908 to S910 are executed at any time according to the user screen operation.

FIG. 15 is a sequence diagram showing an example of processing of the space visualization system 100 according to Embodiment 1. Specifically, FIG. 15 shows a processing sequence among a user 1200, the image storage device 101, a computer 1540, and the image database 110 in image registration processing S1500 and space visualization and image search processing S1520 of the space visualization system 100 described above. The computer 1540 is a computer that implements the image search device 104.

The registration processing S1500 is started when the user 1200 requests the computer 1540 to register data (S1501). The registration processing S1500 corresponds to the processing described in FIG. 7, and is repeatedly executed until the processing of an image file designated by the user is completed. The computer 1540 requests image and position data from the image storage device 101 (S1502), and acquires the image and position data from the image storage device 101 (S1503). The computer 1540 constructs a spatial structure using a plurality of pieces of acquired image and position data (S1504), registers the constructed spatial structure in the image database 110 (S1505), and receives a spatial structure ID (S1506). A series of processing S1507 is performed on each image. In the series of steps S1507, the image semantic information is recognized (S1508), and the spatial position and size of the object are estimated (S1509). The computer 1540 registers the estimated spatial position and size of the object in the image database 110 (S1510), and receives the spatial structure ID (S1511). When the processing for all the images is completed, the user 1200 is notified of registration completion (S1512).

The space visualization and image search processing S1520 corresponds to the processing described in FIG. 9, and the user 1200 starts to request the computer 1540 to display information (S1521). The computer 1540 acquires space information requested to be displayed by the user from the image database 110 (S1522, S1523), and acquires image and object information associated with the space information (S1524, S1525). The information is appropriately processed for display (S1526) and presented to the user 1200 through the display device 103 (S1527). When the user 1200 gives an instruction of a screen viewpoint operation to the computer 1540 through the input device 102 (S1528), the computer 1540 changes the posture information of the virtual imaging device in the three-dimensional space and acquires the posture information (S1529). Then, a query based on a gaze point from the virtual imaging device is generated (S1530), and the image database 110 is searched (S1531). A search result is drawn on the screen of the display device 103, and information is presented to the user (S1532).

As described above, according to the space visualization system 100 in Embodiment 1, a wide variety of objects and events, large and small, existing in a wide range, such as in a disaster situation, can be appropriately visualized in a spatial structure, and the user can quickly grasp the situation.

### Embodiment 2

Next, Embodiment 2 according to the invention will be described. In Embodiment 1, an object detection result is displayed as an icon on the spatial structure, so that a situation of a wide area can be quickly grasped and an access to the necessary image information is facilitated. However, when the number of images increases and various objects and events are detected, a large number of icons are displayed on the screen, which makes it difficult to access desired information. In Embodiment 2, a method for summarizing a large number of pieces of object information in a wide range will be described. In Embodiment 2, the description of the processing and functions same as those in Embodiment 1 will be omitted, and differences will be mainly described.

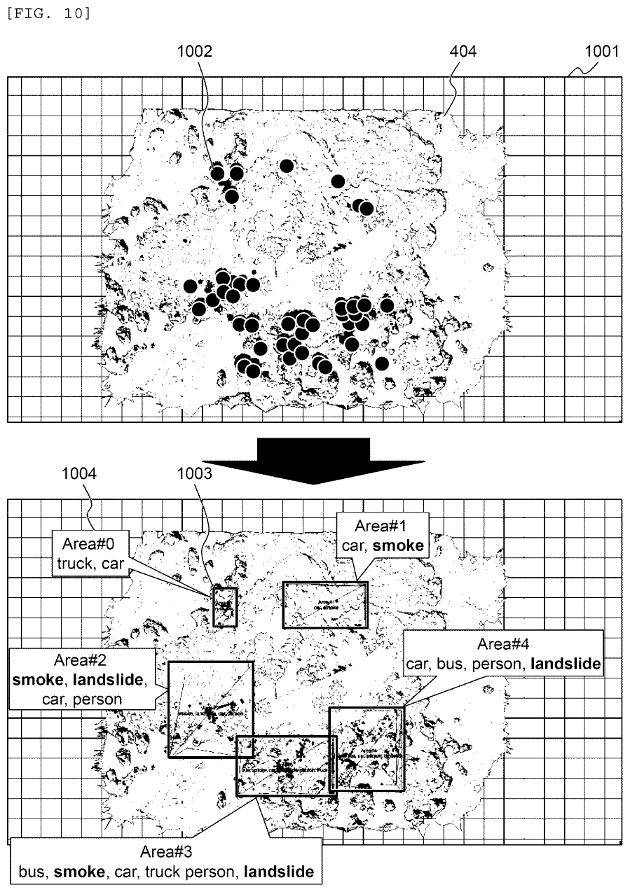

FIG. 10 is a diagram showing an outline of the object information summary processing.

A screen 1001 is a result obtained by displaying the spatial structure 404 and the icon 1002 of the object from an overhead viewpoint. A part of the screen is filled with an object icon, and visibility is reduced. In the summary processing, the object information is grouped using, for example, a data clustering method, and a group icon 1003 is displayed. Types of objects included in the group are displayed as character string labels 1004. A display mode may be changed depending on a combination of the types. For example, when a disaster-related type is included, this type may be highlighted. As the clustering method, for example, a known K-means method can be used. Clustering processing can use vector data indicating spatial positions extracted from each object information. In addition, a type, a size, a direction, a distance, and the like of the object may be added to the vector.

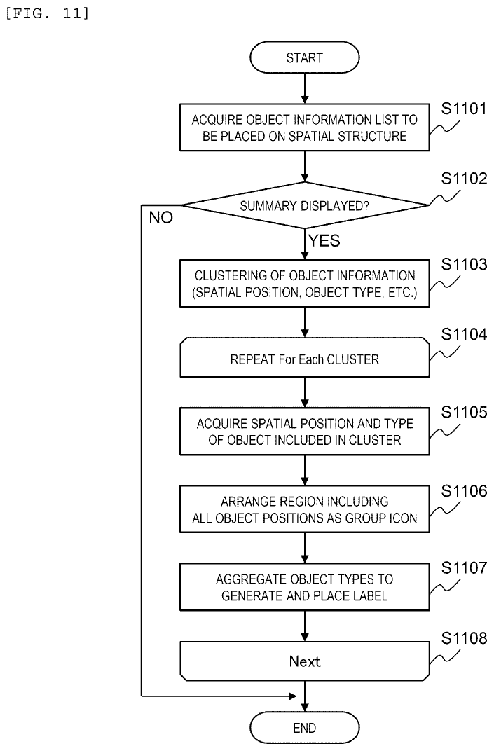

FIG. 11 is a flowchart of the summary processing performed by the image search device 104 according to Embodiment 2. Hereinafter, each step in FIG. 11 will be described.

The image search unit 112 acquires a list of object information to be displayed on the spatial structure (S1101)

The image search device 104 determines whether the summary processing is necessary based on an input from the user or the number of icons to be displayed on the screen, and proceeds to step S1103 when it is determined that the summary processing is necessary, and displays the icon for each object according to the flowchart of FIG. 9 and ends the processing when it is determined that summary processing is not necessary.

The image semantic and spatial structure summary unit 113 generates a vector set based on the object information list acquired in step S1101, and groups the objects by performing the clustering processing on the vector set (S1103). In the generation of the vector set of the object information, the vector can be converted into a vector using a known K-means method or the like using a numerical value of a spatial position of an object or an object type. In the K-means method, since the number of clusters needs to be designated, a numerical value designated by the user or a predetermined value may be used. In addition, an X-means method in which the number of clusters is automatically determined may be used.

The image semantic and spatial structure summary unit 113 executes steps S1105 to S1107 on the cluster obtained in step S1103 (S1104).

The image semantic and spatial structure summary unit 113 acquires the position and type information of the object included in the cluster from the image database 110 (S1105).

The image semantic and spatial structure summary unit 113 generates a group icon 1003 indicating a region including objects included in the cluster, and places the generated group icon 1103 on the spatial structure (S1106).

The image semantic and spatial structure summary unit 113 aggregates the types of all objects included in the cluster, generates the icon label 1004, and displays the generated label 1004 (S1107). The display mode of the label 1004 may be changed depending on the combination of the object types.

When the processing is completed for all clusters, the image search device 104 ends the summary processing.

As described above, according to the space visualization system 100 according to Embodiment 2, in addition to the effects of Embodiment 1, a large amount of image recognition results can be summarized and displayed on the space, and thus the user can efficiently grasp the wide range.

### Embodiment 3

Next, Embodiment 3 according to the invention will be described. In Embodiment 1, an example of a user interface in which details of image information are displayed when a user selects an icon of an object is described. However, when there are a large number of images or objects, it is inefficient to display the necessary information by clicking on each icon one by one. Embodiment 3 discloses a method for automatically generating a search query using context information obtained from a user operation and a state of a three-dimensional viewer and presenting detailed information of an image. In Embodiment 3, the description of the processing and functions same as those in Embodiment 1 will be omitted, and differences will be mainly described.

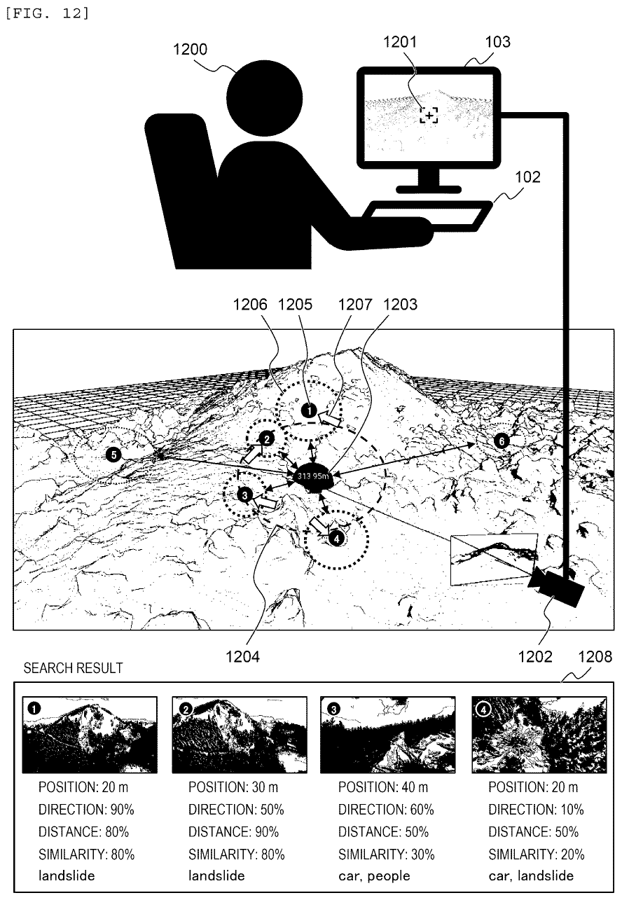

FIG. 12 is a diagram showing an image search utilizing the context of the three-dimensional viewer.

In the space visualization system 100 according to Embodiment 3, the user 1200 operates the spatial structure displayed on the display device 103 with the input device 102 and views the spatial structure while changing a viewpoint. Even if the user 1200 freely changes the viewpoint, a center 1201 of the screen is highly likely to be a gaze point of the user. The spatial structure displayed on the screen is considered to be an image captured from a virtual imaging device 1202 that is freely movable in the three-dimensional space by the user operation. At this time, a position of the gaze point of the user in the three-dimensional structure can be estimated in the same manner as the processing of estimating the three-dimensional position based on the two-dimensional position of the object in the image semantic and spatial structure fusion unit 109. When a three-dimensional position 1203 of the gaze point is estimated, surrounding object information can be automatically acquired from the image database 110. For example, an object included in a predetermined search distance range 1204 from the gaze point is searched. At this time, a distance from the gaze point may be calculated in consideration of not only a spatial position 1205 of the object but also a size 1206. In addition to the distance, a direction in which the image is captured, a distance from the imaging device, similarity of the image, and a type of the object may be added to the search condition. A search result list 1208 is automatically presented to the user.

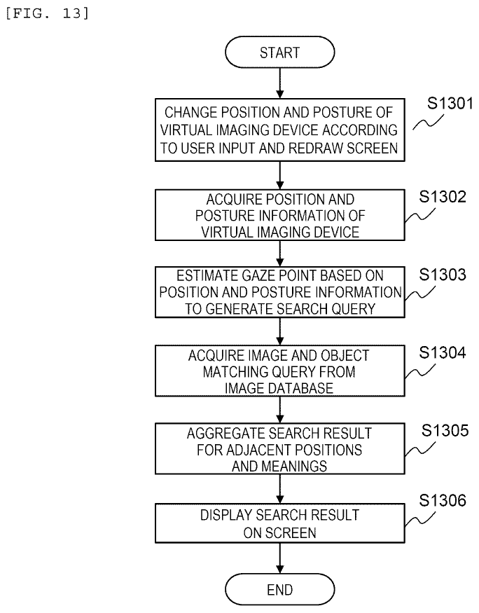

FIG. 13 is a flowchart of context-utilizing image search processing of the image search device 104 according to Embodiment 3. Hereinafter, each step in FIG. 13 will be described.

The display unit 114 changes the position and the posture of the virtual imaging device in the three-dimensional space according to the user input, and draws on the screen the space information viewed from the virtual imaging device (S1301).

The context utilization query generation unit 111 acquires information on the position and the posture of the virtual imaging device from the display unit 114 (S1302). The acquired position and posture of the virtual imaging device are a viewpoint position and a viewing direction.

The context utilization query generation unit 111 estimates a three-dimensional position of a gaze point of the user based on the information on the position and the posture acquired in step S1302, and generates a search query (S1303). In addition to the condition of a distance range from the gaze point, an imaging direction, a distance from the imaging device, and a type of object can be added to the search query. In addition, a similar image search may be performed by calculating an image feature of the image using the space information viewed from the virtual imaging device as the image.

The image search unit 112 acquires information on an image and an object matching the query generated in step S1303 from the image database 110 (S1304).

The image semantic and spatial structure summary unit 113 summarizes a search result as necessary (S1305). The summary processing is the same as the method described in Embodiment 2.

The display unit 114 displays the image and the object information obtained in step S1304 on the screen (S1306). A list of search results may be displayed in a pop-up window or directly in three-dimensional space.

The above processing may be executed with a user operation such as clicking a button as a trigger, or with a change in the position or posture of the virtual imaging device as a trigger.

As described above, according to the space visualization system 100 in Embodiment 3, the user can intuitively generate a search query in conjunction with the viewpoint operation of the three-dimensional viewer, and detailed information of an image can be presented to the user without the user selecting an object, allowing the user to efficiently acquire the necessary information. In particular, when a smartphone, a tablet, a head-mounted display, or the like is used for the input device 102 and the display device 103, it may be difficult to perform an operation of designating detailed conditions on the screen. Therefore, when an acceleration sensor of a device and the viewpoint operation of the three-dimensional viewer are linked, the three-dimensional structure of different viewpoints and the information of the image and the object corresponding thereto can be presented to the user only by moving the device.

In addition, according to the combination of Embodiment 2 and Embodiment 3, for example, when the user zooms out and displays the three-dimensional structure in an overhead view, the summary may be displayed in units of clusters, and when the user zooms in and displays the three-dimensional structure, the icon of each object may be displayed.

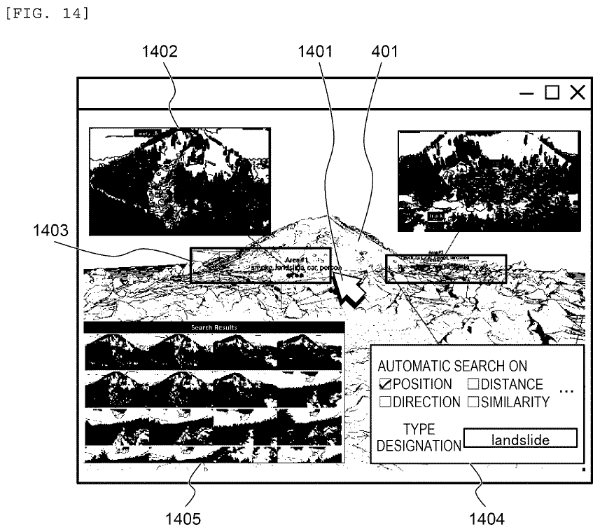

FIG. 14 is a diagram showing a configuration example of an operation screen for visualizing the space information and performing the image search using the image search device 104 according to Embodiments 1 to 3.

The image search device 104 displays a processing result on the display device 103. The user uses the input device 102 to input operation information to the image search device 104 using a mouse cursor 1401 or the like displayed on the screen. The screen displays a spatial structure 401, image detailed information 1402, an object icon or a grouping icon 1403, an image search condition 1404, and an image search result 1405. The image search result 1405 may be displayed in the order of similarity of the image feature, and a display order may be changeable. The configuration example of the screen is an example, and the screen may be implemented by freely arranging these elements.

The invention is not limited to the above embodiments, and includes various modifications and equivalent configurations within the scope of the appended claims. For example, the above-described embodiment is described in detail for easy understanding of the invention, and the invention is not necessarily limited to those including all the configurations described above. A part of a configuration of one embodiment can be replaced with a configuration of another embodiment. A configuration of one embodiment can also be added to a configuration of another embodiment. Another configuration may be added to a part of the configuration of an embodiment, and a part of the configuration of each embodiment may be deleted or replaced with another configuration.

A part or all of the above-described configurations, functions, processing units, processing methods, and the like may be implemented by hardware by, for example, designing with an integrated circuit, or may be implemented by software by, for example, a processor interpreting and executing a program for implementing each function.

Information such as a program, a table, and a file for implementing each function can be stored in a storage device such as a memory, a hard disk, or a solid state drive (SSD), or in a recording medium such as an IC card, an SD card, or a DVD.

Control lines and information lines considered to be necessary for description are shown, and not all control lines and information lines necessary for implementation are shown. Actually, almost all components may be considered to be connected to one another.

1. A space visualization system comprising:
a calculation device configured to execute predetermined calculation processing; and
a storage device accessible by the calculation device, wherein
the calculation device includes a spatial structure recognition unit configured to construct a spatial structure based on a plurality of images,
the calculation device includes an image semantic recognition unit configured to detect an object included in each of the plurality of images,
the calculation device includes an image semantic and spatial structure fusion unit configured to estimate a spatial position of the detected object on the spatial structure, and
the storage device stores information on the image as a source of constructing the spatial structure, the constructed spatial structure, and information on the detected object.

2. The space visualization system according to claim 1, wherein
the storage device stores information on a position and a size of the detected object.

3. The space visualization system according to claim 2, wherein
the storage device stores information on a direction and a distance of the object from an imaging position of the image in which the detected object is imaged.

4. The space visualization system according to claim 1, wherein
the storage device stores a feature of the image as the source of constructing the spatial structure.

5. The space visualization system according to claim 2, wherein
the spatial structure recognition unit estimates a three-dimensional position and a posture of the image based on at least one of information on an imaging position of the image and a value estimated in a processing step of spatial structure construction, and
the image semantic and spatial structure fusion unit estimates a three-dimensional position and a size of the object on the spatial structure based on a two-dimensional position of the detected object in the image, the estimated three-dimensional position and the posture of the image, and the constructed spatial structure, and stores the estimated three-dimensional position and the size in the storage device.

6. The space visualization system according to claim 5, wherein
the image semantic and spatial structure fusion unit estimates the three-dimensional position and the size of the object on the spatial structure, the object being detected within a predetermined range from a perpendicular line to a center position of the image.

7. The space visualization system according to claim 1, wherein
the image semantic and spatial structure summary unit clusters a plurality of the objects according to similarity in information on the objects, and places a group icon indicating a region including all of the objects included in a generated cluster on the spatial structure.

8. The space visualization system according to claim 1, wherein
the image semantic and spatial structure summary unit displays an icon label that varies in a display mode depending on types of all objects included in a cluster.

9. The space visualization system according to claim 1, further comprising:
a context utilization query generation unit configured to acquire a viewpoint position and a viewing direction of space information to be displayed and generate a search query including a three-dimensional position of a gaze point of a user as a condition based on the acquired position and posture information; and
an image search unit configured to acquire an image from the storage device using the generated search query.

10. The space visualization system according to claim 9, wherein
the context utilization query generation unit calculates, using the space information viewed from the viewpoint position as the image, an image feature of the image, and generates the search query including the calculated image feature as a condition.

11. A spatial visualization method executed by a computer,
the computer including a calculation device that executes predetermined calculation processing, and a storage device accessible to the calculation device,
the space visualization method comprising:
a spatial structure recognition step of the calculation device constructing a spatial structure based on a plurality of images;
an image semantic recognition step of the calculation device detecting an object included in each of the plurality of images;
an image semantic and spatial structure fusion step of the calculation device estimating a spatial position of the detected object on the spatial structure; and
a step of the calculation device storing, in the storage device, information on the image as a source of constructing the spatial structure, the constructed spatial structure, and information on the detected object.
